(19) United States
(12) Patent Application Publication
(10) Pub. No.: US 2017/0308139 A1
(43) Pub. Date: Oct. 26, 2017

(54) DAMAGE IDENTIFICATION METHOD FOR REDUNDANT POWER SUPPLY SYSTEM

(71) Applicant: ZIPPY TECHNOLOGY CORP., New Taipei City (TW)

(72) Inventors: Tsun-Te SHIH, New Taipei City (TW); Yu-Yuan CHANG, New Taipei City (TW); Kuang-Lung SHIH, New Taipei City (TW); Heng-Chia CHANG, New Taipei City (TW)

(21) Appl. No.: 15/137,563

(22) Filed: Apr. 25, 2016

(51) Int. Cl. G06F 1/28; G06F 1/26

(52) U.S. Cl. CPC G06F 1/28; G06F 1/263

(57) ABSTRACT

A damage identification method for a redundant power supply system is disclosed. The redundant power supply system comprises a plurality of power supply devices and a control unit. In application of the method, the control unit respectively sends switching signals to the power supply devices to boot every power supply device. The control unit checks whether each of the power supply devices sends back a power state signal. If at least one power supply device does not sends back the power state signal, the control unit resends the switching signal to the power supply device to compulsorily reboot the power supply device, which does not output the power state signal. Thereby is solved the problem that the conventional technology cannot instantly exclude temporary abnormalities and causes the user to misjudge the failure of a power supply device.

### FIELD OF THE INVENTION

The present invention relates to a control method for a redundant power supply system, particularly to a damage identification method for a redundant power supply system.

### BACKGROUND OF THE INVENTION

The current sci-tech industry demands higher and higher reliability of power supply devices. Thus, some manufacturers develop redundant power supply systems. A redundant power supply system mainly comprises a microcontroller and at least two power supply devices. The microcontroller integrates the power output by the power supply devices and provides power to a load (such as an electronic device).

A Taiwan patent No. 1509402 disclosed a power supply device, which comprises a primary power converter and an auxiliary source converter. In application, the primary power converter and the auxiliary power converter are electrically connected with an electronic device. While the primary power converter is in a first operation state, the primary power converter generates a primary power and outputs the primary power to the electronic device. While the primary power converter is in a second operation state, the auxiliary power converter generates an auxiliary power to replace the primary power and outputs the auxiliary power to the electronic device.

In the abovementioned conventional power supply device, the auxiliary power converter can take the place of the primary power converter to keep on supplying power. However, the conventional power supply device can only shift to supply power with the auxiliary power converter while the primary power converter fails. It cannot identify whether the failure of the primary power converter is owing to damage or temporary abnormality. At present, the consumer-end engineering personnel only identify whether the external power source of the power supply device is normal while finding the failure of the power supply device. If the external power source is normal, the consumer-end engineering personnel will determine that the power supply device is damaged and demand the provider to repair the power supply device. However, the provider finds that most of the power supply devices sent back for repair are merely in a temporary abnormality state, which can be solved via merely rebooting the device, and that much management cost is wasted in a multitude of power supply devices that are unnecessarily sent back for repair. Therefore, the conventional power supply device still has room to improve.

### SUMMARY OF THE INVENTION

The primary objective of the present invention is to solve the problem that the conventional technology cannot instantly exclude temporary abnormalities and causes the user to misjudge the failure of a power supply device.

In order to achieve the abovementioned objective, the present invention proposes a damage identification method for a redundant power supply system. The redundant power supply system comprises a plurality of power supply devices and a control unit connected with the plurality of power supply devices. The method of the present invention comprises Step 1: providing a booting request signal to the control unit to make the control unit to generate a plurality of independent switching signals and respectively send the switching signals to the power supply devices to boot every power supply device; Step 2: the control unit receiving a power state signal from each booted power supply device during the operation period thereof, wherein each power state signal includes a power-good message and a corresponding device identifier; the control unit checking whether each power supply device sends out the power state signal; if yes, the control unit determining that the corresponding power supply device operates normally; if no, the control unit resending the switching signal to the corresponding power supply device to compulsorily reboot the corresponding power supply device independently; Step 3: checking whether each compulsorily-rebooted power supply device outputs the power state signal to the control unit; if yes, determining that the corresponding power supply device was merely in a temporary abnormality state and letting the corresponding power supply device keep on supplying power; if no, determining that the corresponding power supply device is damaged.

In one embodiment, a motherboard, which is connected with the redundant power supply system, provides the booting request signal. In one embodiment, the switching signals, which the control unit sends to the power supply devices, respectively have corresponding device identifiers.

In addition to the abovementioned damage identification method for a redundant power supply system, the present invention also proposes a redundant power supply system using the abovementioned method.

In one embodiment, Step 3 further comprises a sub-step: while the control unit still cannot acquire the power state signal, compulsorily rebooting the power supply device, and checking again whether the power state signal of the compulsorily rebooted power supply device is sent out; if yes, determining that the power supply device was merely in a temporary abnormality state; if no, determining that the power supply is damaged. In one embodiment, Step 3 further comprises a sub-step: recording the count of rebooting the power supply device, and comparing the count of rebooting with a limited count; if the count of rebooting is equal to the limited count, forbidding booting the power supply device and determining that the power supply is damaged.

Compared with the conventional technology, the present invention has the following two characteristics:

In the present invention, the control unit uses the switching signals to boot all the power supply devices and checks whether each power supply device sends out the power state signal thereof. If at least one of the power supply devices does not send out the power state signal, the control unit resends the switching signal to compulsorily reboot the power supply device that does not yet send out the power state signal thereof. Then, the control unit checks again whether the power supply device sends out the power state signal thereof. If yes, it indicates that rebooting has excluded the temporary abnormality state. If no, it indicates that the power supply device is damaged. Thereby, the redundant power supply system can use the rebooting operations to verify whether the problematic power supply devices are in a temporary abnormality state or really damaged. Therefore, the present invention can solve the problem that the conventional technology cannot instantly exclude temporary abnormalities and causes the user to misjudge the failure of a power supply device.

### BRIEF DESCRIPTION OF THE DRAWINGS

FIG. 1 is a block diagram schematically showing a circuit of a redundant power supply system realizing a damage identification method according to one embodiment of the present invention;

FIG. 2 is a block diagram schematically showing another circuit of a redundant power supply system realizing a damage identification method according to one embodiment of the present invention;

FIG. 3 is a flowchart of a damage identification method for a redundant power supply system according to one embodiment of the present invention;

FIG. 4 is a diagram schematically showing switching signals and power state signals according to one embodiment of the present invention;

FIG. 5 is a flowchart of a damage identification method for a redundant power supply system according to another embodiment of the present invention; and

FIG. 6 is a flowchart of a damage identification method for a redundant power supply system according to yet another embodiment of the present invention.

### DETAILED DESCRIPTION OF THE PREFERRED EMBODIMENTS

The technical contents of the present invention will be described in detail in cooperation with drawings below.

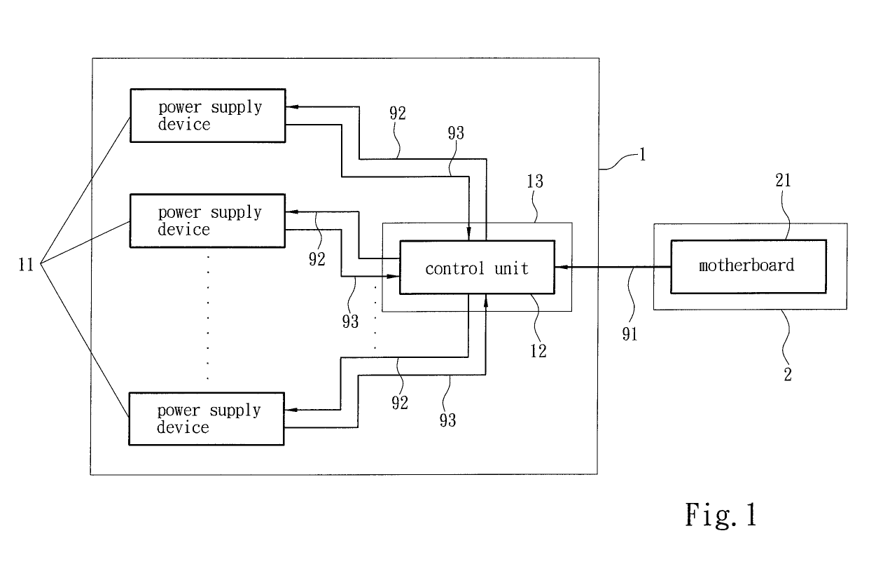

The present invention proposes a damage identification method for a redundant power supply system. Refer to FIG. 1. The redundant power supply system 1 comprises a plurality of power supply devices 11 and a control unit 12. The power supply devices 11 are electrically connected with the control unit 12. In one embodiment, the control unit 12 is a microcontroller unit (MCU). The control unit 12 is used to integrate the powers output by the power supply devices 11 and turn on/off the power supply devices 11. In one embodiment, the control unit 12 is built in a power integration baseplate 13 of the redundant power supply system 1. Each power supply device 11 further comprises a rectifying/filtering unit, a power correcting unit, a voltage transforming unit, and a pulse width controlling unit (not shown in the drawings), which undertake the functions of an ordinary power supply device, such as rectification, wave filtering, and voltage stabilization. The principle and detailed structure of the power supply device 11 is not the focus of the present invention but the prior art in the related field. Therefore, it will not repeat herein.

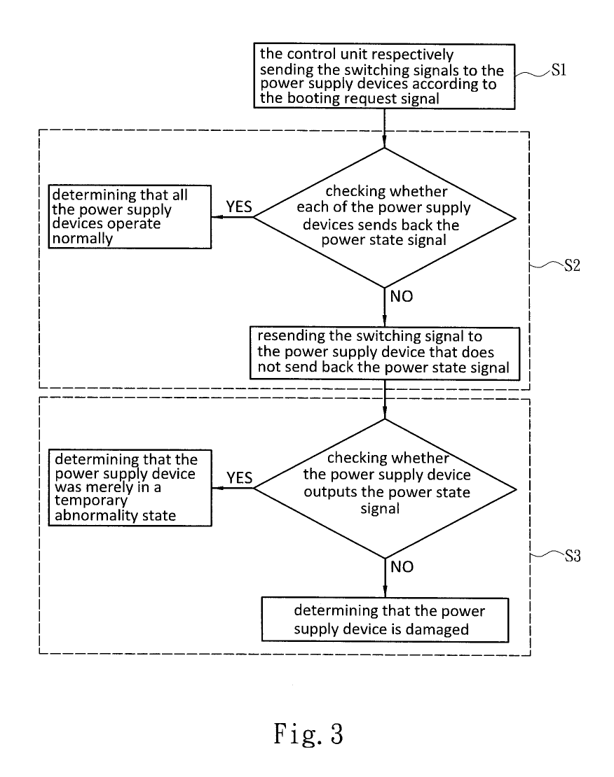

Refer to FIG. 1 and FIG. 3. The method of the present invention comprises Steps S1-S3.

In Step S1, provide a booting request signal 91 to the control unit 12 to make the control unit 12 generate a plurality of independent switching signals 92 and respectively send the switching signals 92 to the power supply devices 11 to boot every power supply device 11.

In Step S2, let the control unit 12 receive a power state signal 93 from each booted power supply device 11 during the operation period thereof. Each power state signal 93 is independent. If the control unit 12 cannot acquire one of the power state signals 93, the control unit 12 resends the switching signal 92 to the corresponding power supply device 11 to compulsorily reboot the corresponding power supply device 11 independently.

In Step S3, check whether the compulsorily rebooted power supply device 11 outputs the power state signal 93 to the control unit 12. If yes, determine that the corresponding power supply device 11 was merely in a temporary abnormality state and let the corresponding power supply device 11 keep on supplying power. If no, determine that the corresponding power supply device 11 is damaged.

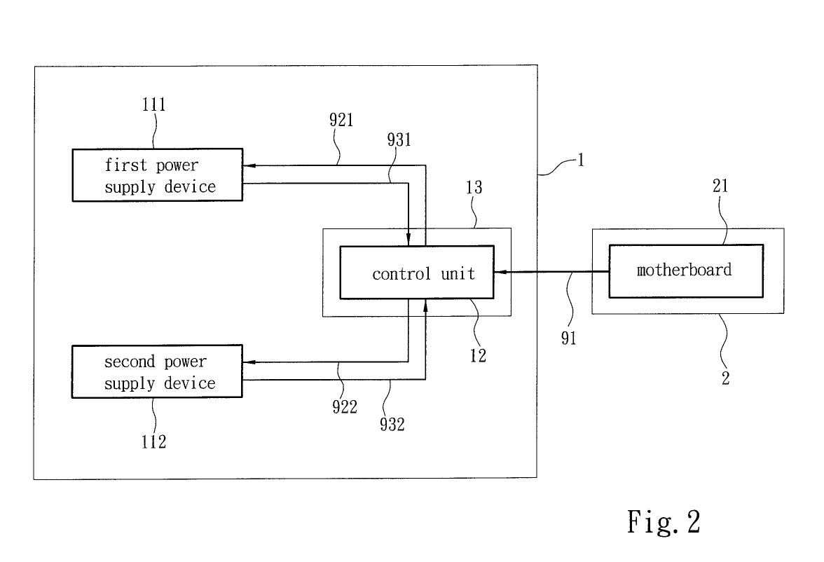

It should be particularly explained: the connection lines of the booting request signal 91, the switching signals 92 and the power state signal 93 in FIG. 1 are only used to demonstrate the following embodiments conveniently; it does not mean that the control unit 12 and the motherboard 21 must be connected by a single electric wire or that the control unit 12 and each power supply device 11 must be connected by two electric wires. In order to explain the embodiments clearly, the power supply devices 11 are classified into a first power supply device 111 and a second power supply device 112, as shown in FIG. 2. None superordinate-subordinate relationship exists between the first power supply device 111 and the second power supply device 112. The quantities of the first power supply devices 111 and the second power supply devices 112 are not limited by FIG. 2.

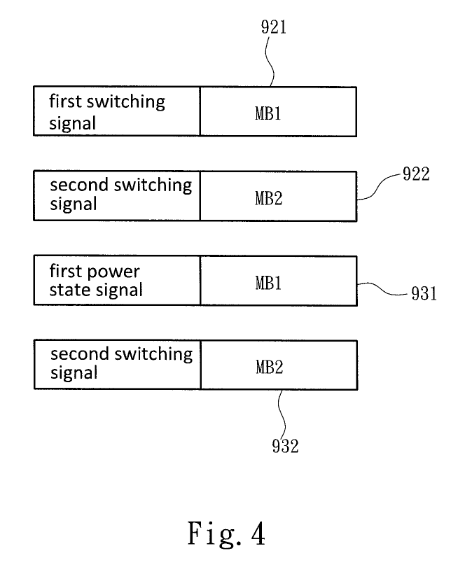

Refer to FIG. 2 and FIG. 4. In application, the redundant power supply system 1 is connected with an electronic device 2. The electronic device 2 is regarded as a load of the redundant power supply system 1. The electronic device 2 includes a motherboard 21, and the motherboard 21 is electrically connected with the control unit 12. In Step S1, the user switches on the electronic device 2, and the motherboard 21 sends the booting request signal 91 (i.e. the PS_ON signal) to the control unit 12. According to the booting request signal 91, the control unit 12 generates a first switching signal 921 and a second switching signal 922 (i.e. the abovementioned switching signals 92), which are independent to each other, and respectively sends the first switching signal 921 and the second switching signal 922 to the first power supply device 111 and the second power supply device 112 to boot the first power supply device 111 and the second power supply device 112.

In the embodiment, the first power supply device 111 and the second power supply device 112 are respectively corresponding to a first device identifier (DID) and a second device identifier, and the first DID is different from the second DID. In FIG. 4, MB1 and MB2 are used to exemplify the first DID and the second DID respectively. The first switching signal 921 includes a first power-on message and the first DID (MB1). The second switching signal 922 includes a second power-on message and the second DID (MB2). The different DIDs make the first switching signal 921 and the second switching signal 922 independent to each other. Thus, in Step S1, the first power supply device 111 uses MB1 to verify whether the first switching signal 921 is addressed to it; if yes, the first power supply device 111 turns on. The second power supply device 112 uses MB2 to verify whether the second switching signal 922 is addressed to it; if yes, the second power supply device 112 turns on.

In Step S2, after turning on according to the first switching signal 921, the first power supply device 111 outputs a first power state signal 931 to the control unit 12; after turning on according to the second switching signal 922, the second power supply device 112 outputs a second power state signal 932 to the control unit 12. Then, the control unit 12 checks whether the first power supply device 111 and the second power supply device 112 operate normally respectively according to the first power state signal 931 and the second power state signal 932. As mentioned above, the first power supply device 111 and the second power supply device 112 are respectively designated with the first DID—MB1 and the second DID—MB2. As shown in FIG. 4, the first power state signal 931 includes a first power-good message (PG) and MB1; the second power state signal 932 includes a second power-good signal (PG) and MB2. Because of involving MB1 and MB2, the first power state signal 931 and the second power state signal 932 are independent to each other. Thus, after receiving the first power state signal 931 and the second power state signal 932 (i.e. the abovementioned power state signals 93), the control unit 12 can learn the correspondence between the first power state signal 931 and the first power supply device 111 and the correspondence between the second power state signal 932 and the second power supply device 112, using MB1 and MB2. Then, the control unit 12 analyzes the information of the first power state signal 931 and the second power state signal 932 to learn whether the first power supply device 111 and the second power supply device 112 operate normally. The first power supply device 111 having turned on normally will send the first power state signal 931 to the control unit 12 after a given interval. The second power supply device 112 having turned on normally will also send the second power state signal 932 to the control unit 12 after a given interval. Therefore, the control unit 12 can learn whether the first power supply device 111 and the second power supply device 112 operate normally according to the first power state signal 931 and the second power state signal 932 respectively at different time points.

In Step S2, the control unit 12 checks whether the first power supply device 111 and the second power supply device 112 respectively send back the first power state signal 931 and the second power state signal 932. If yes, the control unit 12 determines that the first power supply device 111 and the second power supply device 112 operate normally. If no, the control unit 12 sends at least one of the first switching signal 921 and the second switching signal 922 to compulsorily reboot at least one of the first power supply device 111 and the second power supply device 112. Then, the process proceeds to Step S3. In order to clearly demonstrate the method of the present invention, it is supposed in the following description that the second power supply device 112 does not send back the second power state signal 932. However, in practical application, the present invention may handle more than a single power supply device 11 that does not send back the power state signal 93.

In Step S3, the control unit 12 checks once again whether the second power supply device 112 sends back the second power state signal 932. If yes, the control unit 12 determines that the second power supply device 112 was merely in a temporary abnormality state and lets the second power supply device 112 keeps on supplying power. If no, the control unit 12 determines that the second power supply device 112 is damaged and stops sending the second switching signal 922 to the second power supply device 112. Therefore, the method of the present invention uses compulsory rebooting to verify whether the second power supply device 112 of the redundant power supply system 1 is really damaged and solves the problem that the conventional technology cannot instantly exclude temporary abnormalities and causes the user to misjudge the failure of a power supply device.

It should be particularly explained: in Step S2 and Step S3, no matter whether there is at least one power supply device 11 (such as the first power supply device 111 or the second power supply device 112) not sending back the power state signal 93, the control unit 12 undertakes a power supply operation using the power supply devices 11 that have sent back the power state signals 93. In detail, while the redundant power supply system 1 undertakes a power supply operation, the control unit 12 controls the power supply devices 11 to supply power to the motherboard 21 averagely, or controls the power supply devices 11 to supply power to the motherboard 21 alternately.

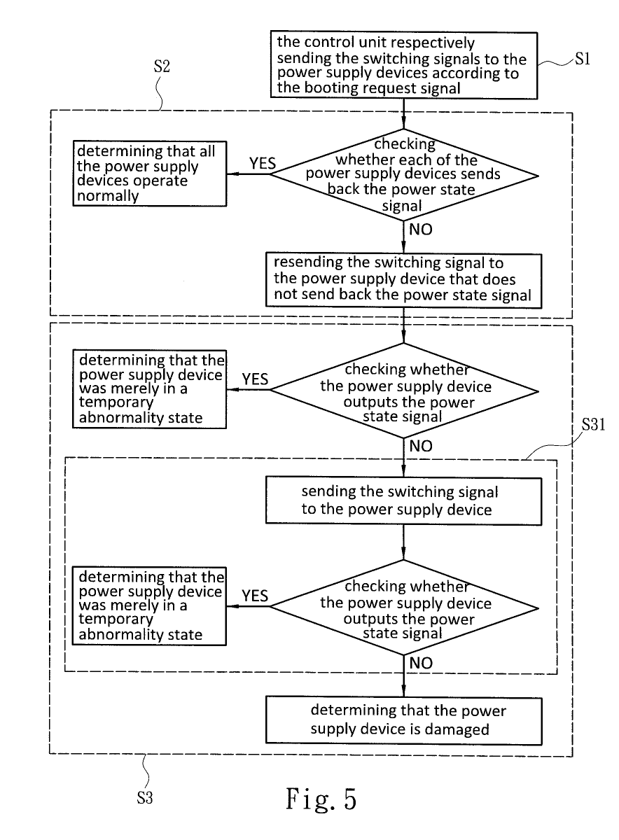

Refer to FIG. 5. In one embodiment, considering several cycles of rebooting activities may be needed to dismiss the temporary abnormality of some power supply devices 11, Step S3 further comprises Sub-Step S31: rebooting the power supply device 11 that does not send back the power state signal 93 once again, and checking whether the power supply device 11 sends back the power state signal 93. In detail, if the control unit 12 still cannot exclude the abnormality with compulsory rebooting in Step S3, the control unit 12 resends the second switching signal 922 to the second power supply device 112 to reboot the second power supply device 112 once again and checks whether the second power supply device 112 sends back the second power state signal 932 in Step S31. If yes, the control unit 12 determines that the second power supply device 112 was merely in a temporary abnormality state and lets the second power supply device 112 keep on supplying power. If no, the control unit 12 determines that the second power supply device 112 is really damaged and would not resend the second switching signal 922. Therefore, the method of the present invention uses multiple compulsory rebooting operations to determine whether the power supply device 11 of the redundant power supply system 1 is really damaged.

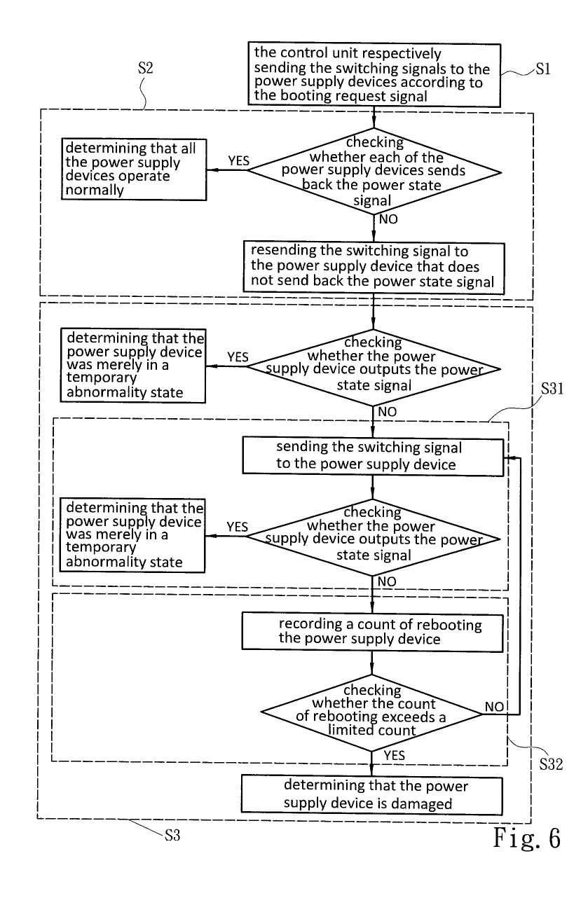

Refer to FIG. 6. In one embodiment, Step S3 further comprises Sub-Step S32: checking whether the count of rebooting the power supply device 11 not sending back the power state signal 93 exceeds a limited count. In detail, if the second power supply device 112 still cannot be rebooted, the control unit 12 records the count of rebooting the second power supply device 112 (i.e. the count of sending the second switching signal 922) and checks whether the count of rebooting the second power supply device 112 has reached the limited count. If yes, the control unit 12 determines that the power supply device 11 of the redundant power supply system 1 is really damaged. If no, Sub-Step S31 is executed once again to reboot the second power supply device 112.

What is claimed is:

1. A damage identification method for a redundant power supply system, wherein the redundant power supply system comprises a plurality of power supply devices each designated with a device identifier (DID) and a control unit connected with the power supply devices, and wherein the method comprises
Step 1: providing a booting request signal to the control unit to make the control unit generate a plurality of independent switching signals according to the booting request signal and respectively send the switching signals to the power supply devices to boot every power supply device;
Step 2: letting the control unit receive a power state signal from each power supply device booted normally during an operation period thereof, wherein each power state signal includes a power-good message and the device identifier corresponding to one of the power supply devices, checking whether each of the power supply devices sends back the power state signal; if yes, determining that all the power supply devices operate normally; if no, resending the switching signal to the power supply device, which does not output the power state signal, to compulsorily reboot the power supply device independently; and
Step 3: checking whether the compulsorily rebooted power supply device outputs the power state signal to the control unit; if yes, determining that the corresponding power supply device was merely in a temporary abnormality state and letting the power supply device keep on supplying power; if no, determining that the power supply device is damaged.

2. The damage identification method for a redundant power supply system according to claim 1, wherein the booting request signal is provided by a motherboard connected with the redundant power supply system.

3. The damage identification method for a redundant power supply system according to claim 2, wherein each switching signal, which is output to one power supply device by the control unit, involves the device identifier of the power supply device.

4. The damage identification method for a redundant power supply system according to claim 3, wherein Step 3 further comprises a sub-step: if the control unit still cannot receive the power state signal, rebooting the power supply device once again, and checking whether the power supply device sends back the power state signal; if yes, determining that the power supply device was merely in the temporary abnormality state and letting the power supply device keep on supplying power; if no, determining that the power supply device is damaged.

5. The damage identification method for a redundant power supply system according to claim 4, wherein Step 3 further comprises a sub-step: recording a count of rebooting the power supply device, and comparing the count of rebooting with a limited count; if the count of rebooting has been equal to the limited count, forbidding booting the power supply device and determining that the power supply is damaged.

6. A redundant power supply system using the damage identification method according to claim 1.

7. A redundant power supply system using the damage identification method according to claim 5.
